(19) United States
(12) Patent Application Publication
(10) Pub. No.: US 2025/0391222 A1
(43) Pub. Date: Dec. 25, 2025

(54) Display Device

(71) Applicant: Scheidt & Bachmann GmbH, Mönchengladbach (DE)

(72) Inventors: Christian Wienand, Viersen (DE); Rachid El Hamoumi, Mönchengladbach (DE)

(21) Appl. No.: 19/247,238

(22) Filed: Jun. 24, 2025

(30) Foreign Application Priority Data
Jun. 25, 2024 (DE) 10 2024 117 896.5

(51) Int. Cl. G07F 9/02; G09G 3/34

(52) U.S. Cl. CPC G07F 9/023; G09G 3/3406; G09G 2330/04; G09G 2360/141

(57) ABSTRACT

A display device includes at least one optical display having a display illumination controllable by a display controller with a control signal and having a transparent protective screen. A light sensor arrangement on the display device has at least one light sensor configured to detect the light intensity emerging at the narrow side of the transparent protective screen and essentially caused by the display illumination. An analysis module is configured to at least detect damage to the transparent protective screen based on the detected light intensity and the control signal applied to the display illumination during the detecting of the light intensity.

### CROSS-REFERENCE TO RELATED APPLICATIONS

This application claims the benefit of German patent application No. 10 2024 117 896.5 filed Jun. 25, 2024, the disclosure of which is incorporated herein by reference in its entirety.

### TECHNICAL FIELD

The invention relates to a display device comprising at least one optical display with a display illumination controllable by a display controller with a control signal and with a transparent protective screen. Furthermore, the invention relates to a method and a ticket vending machine.

### BACKGROUND ART

Ticket vending machines but also other applications comprise optical displays. An optical display can be configured, in particular, to dynamically display different data content respectively variable data content. For example, an optical display can be a touch display. A touch display is configured, in particular, to display variable data content and to detect user inputs.

An optical display is characterized, in particular, by a controllable display illumination. The display illumination, in particular in the form of a background illumination, supports, in particular, the displaying of the data content.

Display devices with an optical display are often found in public areas (e.g., on streets, in train stations, in parking garages, etc.). A fundamental problem in the prior art is that such display devices are repeatedly subjected to vandalism. For example, it is not uncommon for the optical display of a display device to be damaged, for example, by a force (e.g., a blow) being exerted on the front of the optical display by a user.

From the prior art, in order to protect an optical display it is known to arrange a transparent protective screen (e.g., a glass screen) in front of the optical display. If the optical display, comprising the transparent protective screen, is struck, only the transparent protective screen (also referred to as “Opferscheibe”), which forms the front side of the optical display, is damaged. This generally prevents a damage to the electronic components and/or the like of the optical display, but a damaged protective screen at least impairs the displaying of the data content. In particular, the data content displayed by the damaged optical display may be partially or completely unrecognizable to the user. In the case of a touch display, user input may be partially or completely impossible, so that, for example, purchasing of tickets and/or paying for tickets is no longer possible at the ticket vending machine. This results in a loss of income and user dissatisfaction.

Therefore, there is a fundamental need in the prior art to detect a damaged transparent protective screen of an optical display of a display device in real time in order to repair it, in particular, by replacing it with an undamaged transparent protective screen. From the prior art is known in this regard the display device 100 shown in FIG. 1, which comprises a sensor arrangement 198 and, by way of example, is implemented in a ticket vending machine 120.

The display device 100 comprises an optical display 102 with a display layer arrangement 104, a display illumination 106 in the form of a background illumination and a transparent protective screen 108 arranged over the front side 110 of the display layer arrangement 104. At least the display illumination 106 can be controlled by a display controller 112 with a control signal. In addition, the display layer arrangement 104 can be controlled by the display controller 112 with a display control signal.

Furthermore, the display device 100 comprises a sensor arrangement 198 according to the prior art. The sensor arrangement 198 is configured to detect a damage of the transparent protective screen 108. The sensor arrangement 198 comprises a sensor light source 196, a sensor light receiver 194 and an evaluation module 192 connected to the sensor light receiver 194. In the prior art, the sensor light source 196 is located along the entire length of a first narrow side 114 of the transparent protective screen 108 and the sensor light receiver 194 along the entire length of a second narrow side 116 of the transparent protective screen 108. The second narrow side 116 is the narrow side 116 that is located opposite the first narrow side 114.

As indicated by the arrows 118, light is coupled, by the sensor light source 196, into the first narrow side 114 of the transparent protective screen 108. The light 118 transmitted through the transparent protective screen 108 is received by the sensor light receiver 194 on the opposite narrow side and evaluated by the evaluation module 192. The evaluation module 192 is configured to evaluate the degree of transmission respectively the light intensity “passed through” the transparent protective screen 108. If one or more cracks appear in the transparent protective screen 108, for example, due to an impact on the transparent protective screen, the transmitted light intensity decreases. A damaged transparent protective screen 108 can be detected by the evaluation module 192.

However, the sensor arrangement of the prior art has some disadvantages. For example, the sensor arrangement has a complex structure with a sensor light source and a sensor light receiver located opposite each other. In addition, the sensor light source and the sensor light receiver must be arranged in such a way that the entire transparent protective screen can be monitored. As described, the sensor light source is usually arranged along the entire length of a narrow side for this purpose. The same applies to the sensor light receiver. The sensor light source also requires electrical energy so that the energy consumption of the display device as a whole increases. Finally, it has been found that the sensor arrangement of the prior art cannot reliably detect all types of damages. In particular, the front side of the transparent protective screen 108 is repeatedly decorated with paint, stickers and/or the like. Such types of damages are not reliably detected by the sensor arrangement of the prior art since the light continues to be transmitted unchanged from the sensor light source to the sensor light receiver.

Therefore, it is the object of the invention to provide a possibility with which, in the case of a display device with an optical display, the disadvantages of the prior art are at least reduced and, in particular, different types of damages can be detected with improved reliability and at the same time with reduced effort.

### SUMMARY OF THE INVENTION

The object is solved according to a first aspect of the invention by a display device. The display device comprises at least one optical display with a display illumination controllable by a display controller with a control signal and with a transparent protective screen. The display device comprises a light sensor arrangement having at least one light sensor arranged at a narrow side of the transparent protective screen. The at least one light sensor is configured to detect the light intensity emerging at the narrow side and essentially caused by the display illumination. The display device comprises an analysis module. The analysis module is configured to detect at least one damage to the transparent protective screen based on the detected light intensity and the control signal that is present at the display illumination during the detecting of the light intensity.

By providing, in contrast to the prior art, a display device with a sensor arrangement that uses the (already) existing display illumination as a sensor light source, the disadvantages of the prior art are at least reduced and, in particular, different types of damages can be detected with improved reliability and at the same time with reduced effort. It has been recognized in accordance with the invention that if the transparent protective screen is damaged, the light coupled in by the display illumination is reflected in such a way that it is detectable at a narrow side. In particular, it has been recognized that the reflection behavior changes when the transparent protective screen is damaged. In particular, the reflection behavior changes not only when there is a crack (or multiple cracks) caused by an impact, but also when the front side of the transparent protective screen is provided with paint, stickers and/or the like. By taking into account the control signal, the analysis module can determine the changed reflection behavior in the transparent protective screen and, in particular, can thus (immediately and with little effort) detect a damage that has occurred.

According to the invention, a display device is provided. The display device can be a stand-alone device or can be integrated in another device, for example, in a ticket vending machine or the like. In particular, the display device is configured for use in a public space.

The display device comprises an optical display. In particular, the optical display can comprise a display layer arrangement, a display illumination, preferably a display controller and a (replaceable) transparent protective screen. The display illumination can be a backlight and/or a light-emitting layer of the optical display.

The optional display layer arrangement can comprise one or more layers (e.g., a translucent layer or various electrodes, color filters, liquid crystal layer, polarizer, etc.) in a known manner depending on the type of optical display.

The transparent protective screen (also referred to as a protective plate) forms, in particular, the outer front screen of the optical display followed by the display layer arrangement. The transparent protective screen (also referred to as a “Opferscheibe”) is preferably configured to protect the display layer arrangement from a damage. In particular, the transparent protective screen is arranged in a replaceable manner. Preferably, the transparent protective screen can be made of glass or a transparent plastic. In this context, “optically transparent” means, in particular, that the majority of visible electromagnetic radiation is allowed to pass through such a protective screen. In particular, an optically transparent protective screen is to be understood as a screen and a plate, respectively, with a light transmission level of at least greater than 70%, preferably greater than 75%, particularly preferably greater than 80%.

In particular, the display layer arrangement is followed by the display illumination, for example, in the form of a background illumination. A light-emitting layer can also be integrated into a display layer arrangement. The display illumination is configured to illuminate the display layer arrangement and/or the transparent protective screen (in a known manner) in order to display data content of the optical display based on a control signal of the display controller. In particular, the display illumination can be controlled (in a known manner) by the control signal through the display controller (for example, a microprocessor). According to one embodiment of the display device according to the invention, the display layer arrangement can be controlled (in a known manner) by the display controller with a display control signal. In variants of the invention, this can be omitted, for example, if no variable data content is displayed.

In particular, it has been found that the light coupled into the transparent protective screen depends on the control signal applied to the display illumination. In other words, the light coupled first into the display layer arrangement and then into the transparent protective screen, for example, is controlled by the display controller by means of the control signal.

The display illumination is, in particular, configured to couple light into the transparent protective screen in a direction substantially orthogonal to the base surface respectively back side (respectively front side) of the transparent protective screen. In particular, the light is coupled into the back side of the transparent screen (and not via any narrow side).

For example, the optical display may be an LCD (liquid-crystal display) screen, in particular, a touch display. An LCD screen may comprise (in a known manner) a backlight and a display layer arrangement. The optical display can also be an OLED (organic light emitting diode) screen or a micro LED (light emitting diode) screen. An OLED screen can (in a known manner) comprise a display layer arrangement with a light-emitting layer. A micro LED screen can (in a known manner) comprise a display layer arrangement with a light-emitting layer (with micro LEDs).

According to the invention, the sensor arrangement comprises at least one light sensor. The at least one light sensor is configured to detect light, in particular, a light intensity respectively a light level (respectively a light amplitude) of the light. In particular, the at least one light sensor can be a CCD (charge-coupled device) sensor, a photodiode, a phototransistor and/or the like. Preferably, the at least one light sensor can be a line light sensor respectively a line-shaped light sensor.

In particular, the at least one light sensor generates an (electrical) light intensity signal whose amplitude depends, in particular, on the light intensity detected by the light sensor. In particular, the amplitude can depend essentially proportionally on the light intensity detected by the light sensor.

It shall be understood that in variants of the invention, the display device, in particular, the analysis module, can have at least one filter, in particular, to filter out interference components (e.g., noise) from the light intensity signal provided by the light sensor. For example, at least one low-pass filter can be provided.

The transparent protective screen respectively transparent protective plate can comprise a front side (also referred to as the front surface) and a back side (also referred to as the back surface), which is opposite the outer front side. For example, the transparent protective screen can have a thickness between 0.1 cm and 2 cm. The front side and the back side have the base area respectively form it. In particular, the front side and back side are identical, i.e., they have the same outline and the same surface area. At least one narrow side can be arranged between the front side and the back side. In a preferred embodiment, the base area can be rectangular. In this case, the transparent protective screen can have four narrow sides. For example, in the case of a circular base surface, there can be a circumferential narrow side, and in the case of a triangular base surface, there can be three narrow sides.

The at least one light sensor is arranged at the at least one narrow side (and thus not on the front side or back side) of the transparent protective screen. In particular, each light sensor of the sensor arrangement is arranged at a narrow side. In other words, there can be no light sensor on the front side or on the back side.

According to the invention, the at least one light sensor detects the light intensity coupled out (at the corresponding narrow side of the transparent protective screen). The light intensity detectable at the narrow side is essentially caused by the display illumination. In the present case, essentially caused by the display illumination means, in particular, that in practice it is almost unavoidable that the ambient light is also causally responsible to a small extent (e.g., 0 to 5%) for the light intensity that can be detected at the narrow side by a light sensor. However, the display device itself does not have any other light source that can be the cause of the detectable light intensity.

In addition, the display device comprises an analysis module, for example, formed by hardware and/or software. The analysis module is, in particular, configured to evaluate the detected light intensity and the control signal. In particular, the at least one light sensor can be configured to (continuously measure and continuously) provide the light intensity signal generated by the light sensor depending on the light intensity detected by this light sensor.

Furthermore, the display controller can be configured to at least (continuously) provide the control signal used to control the display illumination. Preferably, a temporally synchronized evaluating of the at least one light intensity signal and of the control signal can be carried out by the analysis module.

In particular, it has been recognized that a damage to the transparent protective screen cannot be reliably detected on the basis of the detected light intensity alone since the detectable light intensity also always depends on the light coupled into the transparent protective screen. By the analysis module being configured, in particular, to evaluate the light intensity detected by the at least one light sensor and the control signal, in particular, to evaluate the at least one light intensity signal and the control signal in a temporally synchronized manner, a damage to the transparent protective screen can be (almost immediately) detected. This is, in particular, possible in the case of a damage in the form of stickers and/or paint, which only lead to a slight change in reflection behavior.

According to a preferred embodiment of the display device according to the invention, the light sensor arrangement can exclusively comprise and use, respectively, the display illumination as a light sensor source. In other words, the light sensor arrangement cannot have a separate light sensor source (as in the prior art). In particular, no light sensor source is arranged at a narrow side of the transparent protective screen. Preferably, the light sensor arrangement uses only the display illumination as a light sensor source. The assembly effort and the energy consumption of the display device according to the invention can be reduced.

According to a further embodiment of the display device according to the invention, the control signal can be a pulse width modulation signal (PWM signal). In particular, at least the brightness respectively light intensity with which the optical display is operated can be controlled by means of a PWM signal.

According to a further preferred embodiment of the display device according to the invention, the analysis module can be configured to detect a damage to the transparent protective screen by detecting a minimum change of the detected light intensity (in particular, of the detected amplitude of the at least one provided light intensity signal) with a simultaneously, in particular, unchanged control signal (respectively an unchanged amplitude of the control signal). In particular, the temporal behavior of the provided light intensity signal can be evaluated together with the temporal behavior of the control signal. Upon a detecting of a change of the detected light intensity greater than the (pre-definable) minimum change (for example, a pre-defined amplitude change), in particular, without the control signal having changed, that is to say without the light intensity coupled into the transparent protective screen by the display illumination having changed, a damage to the transparent protective screen can be detected. In particular, a damaged protective screen is detected with increased reliability.

According to a further embodiment of the display device according to the invention, the analysis module can be configured to determine, in particular as a minimum change, a dynamic minimum change (e.g., an amplitude change), based on the control signal present at the display illumination during the detecting of the light intensity. The analysis module may be configured to detect a damage to the transparent protective screen based on the dynamic minimum change and the detected light intensity (respectively the maximum amplitude of the light intensity signal). In particular, it has been recognized that the required minimum change may depend on the applied control signal. By taking the control signal into account, the detecting of a damage to the transparent protective screen can be further improved.

According to a preferred embodiment of the display device according to the invention, the analysis module can be configured to determine a difference (level difference respectively amplitude difference) between a maximum respectively a maximum amplitude of the control signal and a maximum respectively a maximum amplitude of the detected light intensity respectively the provided light intensity signal. The analysis module can be configured to determine a degree of damage to the transparent protective screen based on the determined difference. For example, two or more different degrees of damage (e.g., slightly, moderately, severely or partially damaged, completely damaged, etc.) can be predefined. Depending on the determined difference, in particular, the amount of the determined difference, the associated degree of damage can be determined (for example, using a mapping table in which (dynamically determined) height ranges are each assigned to a degree of damage).

Preferably, the analysis module can be configured to determine a (level or amplitude) difference between the (dynamically determined) minimum change and the maximum of the detected light intensity (respectively the light intensity signal).

Depending on the determined degree of damage, it is possible, in particular, to evaluate whether an immediate repair (in particular, replacement of the damaged protective screen) should be carried out or whether it can be carried out at a later time since predominant functionality is still given. In particular, in the case of a plurality of damage messages, each containing at least the degree of damage, the available repair resources can be used efficiently.

According to a further embodiment of the display device according to the invention, the light sensor arrangement can comprise at least two light sensors. The at least two light sensors can be arranged at a distance (for example between 0.5 cm and 30 cm) from one another. Preferably, the two light sensors can be arranged on two different narrow sides of the transparent protective screen. The detection sensitivity of the sensor arrangement can be improved by providing at least two light sensors that are arranged at a distance from one another. Preferably, a first light sensor can be arranged at a first narrow side and a second light sensor can be arranged at a further narrow side that is located opposite the first narrow side. Even minor damage can be detected.

According to a further preferred embodiment of the display device according to the invention, the transparent protective screen can have a substantially rectangular base shape respectively surface, in particular, as has already been described. At least at three of the four narrow sides of the transparent protective screen, a respective light sensor can be arranged, preferably at all four narrow sides of the transparent protective screen. In that at least one light sensor is arranged, in particular, at each narrow side of the transparent protective panel, the detection sensitivity can be improved even further. In particular, one or more light sensors can be arranged at each narrow side of the transparent protective panel since, as described, in contrast to the prior art, a light sensor source at a narrow side can be dispensed with.

According to a particularly preferred embodiment of the display device according to the invention, the at least two light sensors can each be configured to provide a respective light intensity signal, in particular, as already described. The analysis module can be configured to determine a main damage position based at least on the respective light intensity of the two light intensity signals (and, in particular the respective sensor position). In other words, at least two of the light sensors of the sensor arrangement, preferably all of the light sensors of the sensor arrangement, can be used to determine a main damage position.

As already described, preferably three or more light sensors arranged distributed at the narrow side(s) can be provided. In particular, at least one light sensor can be arranged at each narrow side.

The respective light sensor positions of the respective light sensors of the sensor arrangement can be known to the analysis module. In particular, a respective light intensity signal provided respectively received by the analysis module can be assigned to a respective light sensor (or the respective light sensor position) by the analysis module.

At least two of the received light intensity signals can be evaluated by the analysis module. In particular, the respective light intensity signals provided by the two or more light sensors can be evaluated by the analysis module, preferably their respective (level or amplitude) maxima are compared with each other. In particular, it has been recognized that the light sensor having the light intensity signal with the highest amplitude is the light sensor of the light sensors closest to the main damage position, while the light sensor having the light intensity signal with the lowest amplitude is the light sensor of the light sensors farthest from the main damage position. Preferably, a triangulation technique or the like can be used by the analysis module, based on the respective maxima of the provided light intensity signals, to determine the main damage position. In particular, with at least four, preferably more, light sensors distributed at the narrow sides and by a corresponding evaluating of the provided light intensity signals, the main damage position can be reliably determined.

In particular, the analysis module can be configured to determine the respective distance of the respective light sensor to the main damage position, based on the respective position of the respective light sensor and the respective maximum amplitude of the respective light intensity signal.

A main damage position and a main damage position area, respectively, in the present case refers, in particular, to the area of the transparent protective screen that is substantially damaged, for example, that has cracks and/or the crack, or has a sticker or paint. For example, a main damage position can be specified in the form of coordinates of a predefined coordinate system applied to the transparent protective screen. As will be described, a main damage position can also be defined, for example, by specifying the grid sub-areas that show damage.

According to a further preferred embodiment of the display device according to the invention, the display device can comprise the display controller as already described. The display controller can be configured to change the data content displayed by the optical display by controlling the display illumination and/or the display layer arrangement based on the determined main damage position (and in particular the additionally determined degree of damage). In particular, the analysis module can provide the display controller with a determined main damage position and, in particular, a determined degree of damage. Changing the data content displayed by the optical display can be done by the display controller using a modified control signal and/or a modified display control signal.

For example, changing the data content displayed by the optical display by means of the display controller may comprise reducing the size of the window in which the entire data content is displayed, in particular depending on the main damage position (and, if necessary, on a predefined minimum window size). Furthermore, the reduced window can be displayed in an (damage-free or low-damage) area of the optical display depending on the main damage position. In other words, the reduced window can be displayed in an area of the optical display that has no or only minor damage.

Alternatively or additionally, the data content can comprise a plurality of (separate) data elements. Each data element can be assigned a display priority. For example, a data element that should always be displayed (e.g., an important information piece for a user, a keypad that can be operated by a user, a data element that is essential for the function of the display device or the device in which the display device is implemented, etc.) should be given a high, in particular, the highest, priority, while a data element that does not always have to be displayed (e.g., an advertisement, an area without a user-operable keypad, a data element that is not essential for the function of the display device or the device in which the display device is implemented, etc.) should be given a low, in particular, the lowest, priority.

Changing the data content displayed by the optical display by means of the display controller can comprise displaying the data elements in the (damage-free and low-damage, respectively) area of the optical display that has no or only minor damage, depending on the priority assigned in each case. Initially, only the at least one data element with the highest priority is displayed in the low-damage area of the optical display. If a further sub-area in the low-damage area of the optical display is available, the at least one further data element with the second highest priority can be displayed (and so on). Data elements that can no longer be displayed in the low-damage area of the optical display (due to lack of space and, in particular, due to priority) can be omitted altogether or displayed in the main damage area.

In particular, controlling the display illumination with a modified control signal and/or display control signal comprises controlling it in such a way that at least one user-operable control panel of a touch display is displayed outside the main damage position.

Even if a transparent protective screen is damaged, continued operation of the display device and/or of the device in which the display device is implemented can be ensured in the best possible way, in particular, until the display device is repaired. Then the optical display can be controlled again in such a way that the original data content is (completely) displayed on the entire display area of the optical display.

According to a further preferred embodiment of the display device according to the invention, the display device can comprise the display controller, as already described. The display controller can be configured to control the display illumination with a predefined test control signal (as a control signal for the display illumination) during a predefined test period. The analysis module can be configured to detect a damage to the transparent protective screen based on the light intensity detected during the test period and the test control signal. In particular, it has been recognized that the detection sensitivity can be further improved by a special test control signal, in which, in particular, light with a predefined brightness and/or predefined intensity is coupled in, which is particularly suitable for detecting a damage to a transparent protective screen. For example, the test control signal can be formed in such a way that light with a maximum brightness and/or intensity is coupled in.

According to a further embodiment of the display device according to the invention, the predefined test control signal can be generated based on a predefined time-dependent test sequence pattern, with which, in particular, the entire screen area of the optical display is controlled, preferably in a raster-like (respectively grid-like) manner. In particular, a grid (for example, with rectangles or similar grid sub-areas) can be placed over the entire screen area of the optical display. Each of these grid sub-areas can then be activated, for example, sequentially, in particular, with a predefined light intensity and/or light brightness and/or color (while the other grid sub-areas are not illuminated). With such a test scenario, the entire screen area of the optical display can be scanned with regard to a damage to the transparent protective screen. In particular, an evaluating of the at least one light intensity signal, in particular, of a plurality of light intensity signals, can be carried out for each grid sub-area, as described above. For example, the respective maximum amplitudes of the respective light intensity signals for all grid sub-areas can be compared with each other again. For example, it can be determined for which grid sub-area the at least one amplitude of the plurality of light intensity signals of all grid sub-areas is the highest. These grid sub-areas can be determined, in particular, as the main damage position area. In particular, the main damage position area can be determined in an even more reliable manner.

Controlling the display lighting with a predefined test control signal can preferably comprise displaying a predefined time-dependent test pattern through the optical display for a predefined test period, as described. In addition, controlling can be carried out with a predefined test display control signal.

The test sequence pattern respectively the test control signal can be stored in a data memory of the display device. The display controller can be configured to perform the test procedure at predefined points in time (e.g., regularly, if no user action is/was detected (e.g., for a predefined period of time) and/or the like).

For example, the test control signal can be a DC voltage signal and/or can be configured in such a way that different (predefined) colors are displayed.

According to a further embodiment of the display device according to the invention, a reflective layer can be arranged on at least some of the narrow side areas of the transparent protective screen (in particular, on which no light sensor is arranged). A reflective layer on the narrow sides, on which no light sensor is arranged, allows light to be reflected by the reflective layer and, in particular, to be detected by the at least one light sensor. The measurement sensitivity can be further improved. Even small damages to the transparent protective screen can be detected.

According to a further embodiment of the display device according to the invention, the display device can comprise a holding frame. The holding frame is, in particular, configured to (mechanically) hold the transparent protective screen. For example, the transparent protective screen can be (precisely) inserted into the holding frame. The holding frame can comprise fastening means for fastening the holding frame to a housing (or similar) of the display device and/or of the device in which the display device is implemented.

The holding frame can preferably comprise the at least one light sensor. In particular, the light sensor can be integrated in the holding frame in such a way that the light sensor is arranged at a narrow side of the transparent protective screen (in particular, in such a way that light emerging on the narrow side is detected by the light sensor) in an inserted state of the transparent protective screen, i.e., when it is (properly inserted) in the holding frame. For example, the light sensor can be in direct contact with the narrow side when inserted. The holding frame can comprise electrical contact means for a communication connection with the analysis module. It is possible to simply replace a damaged transparent protective screen. In addition, the at least one light sensor can be reused with each new transparent protective screen. The transparent protective screen itself does not have to be provided with a light sensor.

Furthermore, the reflective layer can preferably be attached to the holding frame in such a way that a reflective layer is arranged on at least part of the narrow side areas (in particular, where no light sensor is arranged) of the transparent protective screen. It is possible to easily replace a damaged transparent protective screen. In addition, the at least one reflective layer can be reused with each new transparent protective screen. The transparent protective screen itself does not need to be provided with a reflective layer. The reflective layer further improves the detection sensitivity.

According to a further embodiment of the display device according to the invention, the at least one light sensor can be (completely) surrounded by the narrow side of the transparent protective screen and an opaque encapsulation. The encapsulation can be formed, in particular, by the holding frame (described above). By providing an encapsulation, it can be achieved that ambient light is only causally responsible for the light intensity detectable at the narrow side by the at least one light sensor to a very small extent (e.g., 0 to 1%). The reliability in detecting a damage can be improved even further.

According to a further embodiment of the display device according to the invention, the display device can comprise at least one communication module. The communication module can be configured to transmit at least one damage message (via a (wireless and/or wired) communication network to a control center) upon detecting of a damage to the transparent protective screen. In particular, the damage message can be generated and transmitted immediately upon detecting a damage to the transparent protective screen. The damage message can contain an identifier of the display device and/or the device in which the display device is implemented and/or a position indication of the display device and/or the device in which the display device is implemented. In particular, the location can be determined from the identifier, for example, by means of a location database. Furthermore, the damage message can preferably contain at least the degree of damage. Based on a damage message, the control center can cause a repair of the damaged transparent protective screen, in particular, a replacement of the damaged transparent protective screen.

A further aspect of the invention is a method for detecting a damage to an optical display of a display device, in particular, a previously described display device (according to claim 1). The method comprises:
detecting, by means of at least one light sensor arranged at a narrow side of a transparent protective screen of the optical display, an emerging light intensity that is essentially caused by the display illumination, and
detecting, by an analysis module (of the display device), a damage to the transparent protective screen, based on the detected light intensity and a (provided) control signal that is present at a display illumination of the optical display during the detecting of the light intensity.

In particular, the method can comprise receiving the control signal, which is present during the detecting of the light intensity at a display illumination of the optical display, from the display controller.

Preferably, (immediately) upon detection of a damage to the transparent protective screen, a transmitting, by a communication module of the display device, of a damage message can be caused, as has been described hereinbefore.

A still further aspect of the invention is a ticket vending machine. The ticket vending machine comprises at least one ticket processing module. The ticket vending machine comprises at least one previously described display device (according to claim 1). The at least one ticket processing module can be a ticket generation module, a ticket accounting module, a ticket issuing module, a ticket validation module and/or the like.

In further variants of the invention, the display device can be implemented in other devices or form these devices, such as information displays and/or the like.

A module (e.g. analysis module) described above, a device, a mechanism, etc. can comprise at least partly hardware elements (e.g. processor, storage means, etc.) and/or at least partly software elements (e.g. executable code). It should be noted that terms such as “first”, “second”, “further” etc. do not indicate an order, but serve in particular to distinguish two elements (e.g. light sensor etc.).

The features of the display devices, the ticket vending machines, and the methods can be freely combined with each other. In particular, features of the description and/or the dependent claims, including features that completely or partially bypass features of the independent claims, can be independently inventive in their own right, either alone or in any combination, with or without other features.

### BRIEF DESCRIPTION OF THE DRAWINGS

There are now a multitude of possibilities for designing and further developing the display devices, ticket vending machines and method according to the invention. In this regard, reference is made, on the one hand, to the patent claims subordinate to the independent patent claims and, on the other hand, to the description of embodiments in conjunction with the drawing. The drawings show:

FIG. 1 a schematic view of a ticket vending machine with a display device according to the prior art,

FIG. 2 a schematic view of an embodiment of a display device according to the present invention,

FIG. 3a a schematic plan view of a further embodiment of a display device according to the present invention,

FIG. 3b a schematic sectional view of the display device according to FIG. 3a,

FIG. 4a a schematic plan view of a further embodiment of a display device according to the present invention in a damage-free state,

FIG. 4b a schematic plan view of the display device according to FIG. 4a in a damaged state,

FIG. 4c a further schematic plan view of the display device according to FIG. 4a in a damaged state,

FIG. 4d a further schematic plan view of the display device according to FIG. 4a in a damaged state with a grid,

FIG. 5 a diagram of an embodiment of a method according to the invention,

FIG. 6 a schematic view of an embodiment of a ticket vending machine according to the invention with an embodiment of a display device according to the present invention,

FIG. 7a exemplary signal curves of an intensity signal and a control signal in a damage-free state of the display device according to the present invention,

FIG. 7b exemplary signal curves of an intensity signal and a control signal in a damaged state of the display device according to the present invention, and

FIG. 7c further exemplary signal curves of an intensity signal and a control signal in a damaged state of the display device according to the present invention.

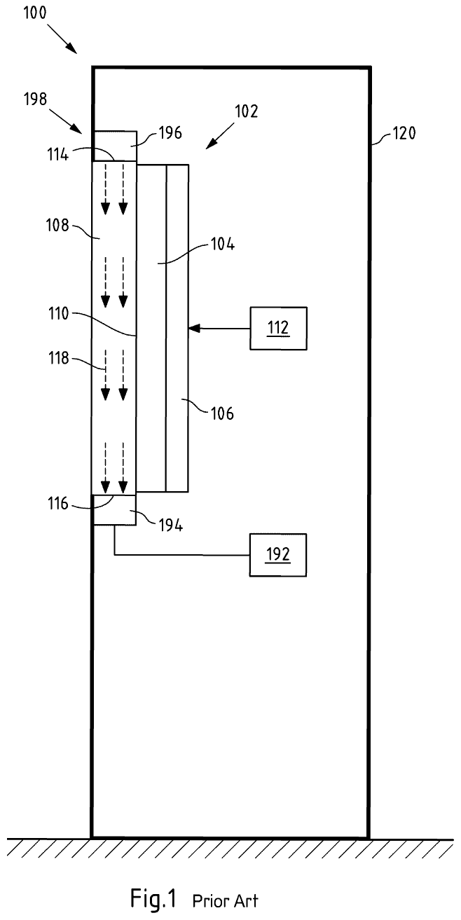

In the following, similar reference signs are used for similar elements.

### DETAILED DESCRIPTION OF SPECIFIC EMBODIMENTS

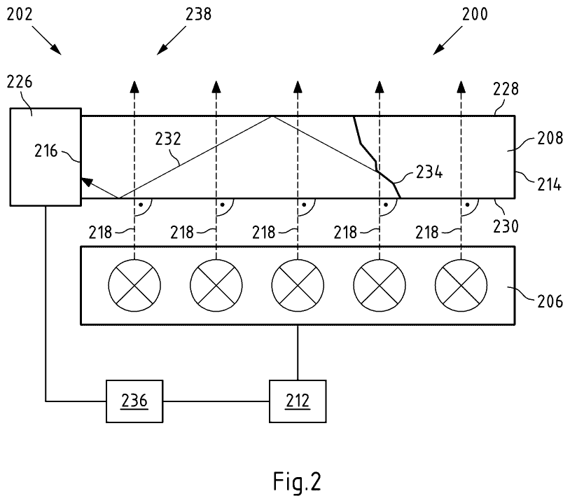

FIG. 2 shows a schematic view of an embodiment of a display device 200 according to the present invention. The display device 200 can be a stand-alone device or can be integrated in another (not shown) device, for example, a ticket vending machine. In particular, the display device 200 is configured for use in a public space.

The display device 200 comprises at least one optical display 202. The optical display 202 comprises at least one display illumination 206 and at least one transparent protective screen 208. Preferably, the optical display 202 comprises at least one display controller 212, for example, formed by a microprocessor and/or the like. The transparent protective screen 208 can be made of glass and/or a plastic material.

The transparent protective screen 208 is, in particular, formed in the shape of a plate with a front side 228, a back side 230 and at least one narrow side 214, 216. The front side 228 is, in particular, directed outwards (in the direction of a user not shown). The back side 230 faces the display illumination 206.

The display illumination 206 is, in particular, controllable by means of the display controller 212. The display controller 212 is at least configured to control the display illumination 206 by means of a control signal.

Furthermore, a light sensor arrangement 238 of the display device 200 comprises at least one light sensor 226 arranged at a narrow side 216 of the transparent protective screen 208. The light sensor 226 is, for example, a CCD sensor or a photodiode or the like. The at least one light sensor 226 is configured to detect the light intensity emerging at the narrow side 216 and essentially caused by the display illumination 206.

As can also be seen from FIG. 2, the display illumination 206 is, in particular, configured to couple light 218 into the transparent protective screen 208 in a direction essentially orthogonal to the base side respectively back side 230 (respectively front side 228) of the transparent protective screen 208 (indicated by the right angles between an arrow representing the light and the back side 230).

In particular, the light sensor arrangement 238 comprises only the display illumination 206 as a light sensor source (and thus no separate light source).

In particular, the invention makes use of the fact that the reflection behavior changes if the transparent protective screen 208 is damaged 234. For example, FIG. 2 shows a crack as a damage 234. The damage 234 causes the light 218 that strikes this damage to be partially deflected (scattered) and partially reflected (see arrow 232). As can be seen, this reflected light 232 emerges, for example, at the narrow side 216 and can be detected respectively sensed by the light sensor 226. In particular, only a low light intensity is detectable at the narrow side without a corresponding damage due to the orthogonal coupling of the light into the base side respectively back side 230 (respectively front side 228) of the transparent protective screen 208, as described.

In particular, the light sensor 226 can provide the detected light intensity in the form of an (electrical) light intensity signal to the analysis module 236. Furthermore, the display controller 212 can provide the control signal to the analysis module 236.

The analysis module 236 is configured to at least detect a damage 234 to the transparent protective screen 208 based on the detected light intensity (in particular, the amplitude profile of the (electrical) light intensity signal) and the control signal (in particular, the amplitude profile of the (electrical) control signal) that is present at the display illumination 206 during the detecting of the light intensity.

This detecting comprises, in particular, a (synchronized) evaluating of a light intensity signal of the light sensor 226 and of the control signal. In particular, the amplitude of the light intensity signal and the amplitude of the control signal can be evaluated by the analysis module 236 in order to detect a damage 234. Preferably, the analysis module 236 can be configured to detect a damage to the transparent protective screen 208 by detecting a minimum change in the detected light intensity (detected amplitude), in particular, with a simultaneously unchanged control signal. For example, the analysis module 236 may be configured to determine, as the minimum change, a dynamic minimum change based on the control signal present at the display backlight 206 during the detecting of the light intensity. The analysis module 236 may be configured to detect a damage to the transparent protective screen based on the dynamic minimum change and the detected light intensity.

The optical display 202 may be, for example, an LCD screen or an OLED screen or a Micro LED screen.

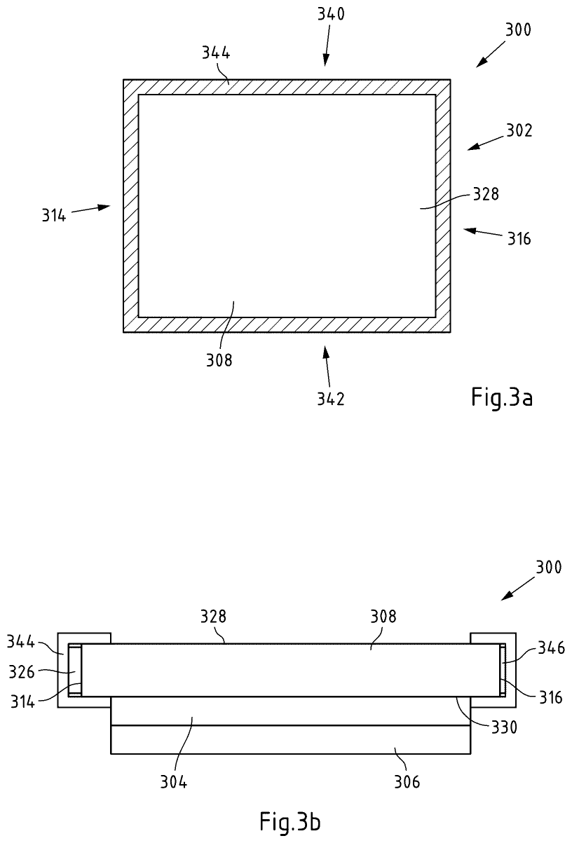

FIGS. 3a and 3b show a plane respectively top view and a sectional view of a further embodiment of a display device 300 according to the present invention. In order to avoid repetitions, only the differences to the embodiment according to FIG. 2 will be explained below, otherwise, for example, reference is made to the explanations to FIG. 2. Furthermore, only for the sake of a better overview, the representation of details has been dispensed with in the present case, such as the display controller and the analysis module.

The display device 300 comprises an optical display 302. In the present embodiment, the optical display 302 comprises a transparent protective screen 308, a display layer arrangement 304 (with one or more layers, as described), a display illumination 306 and a (not shown) display controller.

The illustrated transparent protective screen 308 comprises a front side 328 and a back side 330, as well as four narrow sides 314, 316, 340, 342. In particular, the transparent protective screen 308 has a rectangular base shape respectively area. The base shape of the display layer arrangement 304 and the shape of the display illumination 306 can correspond to the base shape of the transparent protective screen 308.

Preferably, at least two narrow sides 314, 316, 340, 342, preferably at least three narrow sides 314, 316, 340, 342, in particular preferably, each narrow side 314, 316, 340, 342, can comprise at least one light sensor 326 (for a better overview, only a single light sensor 326 is shown).

The display device 300 comprises, in particular, a holding frame 344. In particular, at least the transparent protective screen 308 can be insertable in the holding frame 344 (with a precise fit) and can be, in particular, interchangeably. The holding frame 344 can have (not shown) fastening means in order to fasten the holding frame 344 in an exchangeable manner, for example, to a housing of a device in which the display device 300 is installed. The further elements of the optical display 302 can be installed in the housing of the device.

As can be seen, the at least one light sensor 326 can be arranged in the holding frame 344, in particular, fixed therein. By means of (not shown) electrical contact means, which can be integrated in the holding frame, a (wired) connection can be made to the analysis module in an installed state of the holding frame 344. The at least one light sensor 326 is arranged in the holding frame 344 in such a way that, in an inserted state of the transparent protective screen 308, the light sensor 326 makes, in particular, direct contact with a narrow side 314, 316, 340, 342.

Optionally, a reflective layer 346 can be arranged at at least a portion of the narrow side areas (in particular, where no light sensor 326 is arranged) of the transparent protective screen 308. A reflection layer 346 at the narrow sides 314, 316, 340, 342 respectively their sub-areas, on which no light sensor 326 is arranged, allows light to be reflected by the reflection layer 346 and, in particular, to be detected by the at least one light sensor 326. The reflective layer 346 can be attached to the holding frame 344 in such a way that a reflective layer 346 is arranged at least on that part of the narrow side areas (in particular where no light sensor 326 is arranged) of the transparent protective screen 308.

In particular, the holding frame 344 can be formed from a light-impermeable material. As a result, the holding frame 344 can be used as an encapsulation for the at least one light sensor 326. Preferably, the at least one light sensor 326 can be surrounded by the narrow side 314, 316, 340, 342 of the transparent protective screen 308 and an opaque encapsulation (in the present case formed by the holding frame 344).

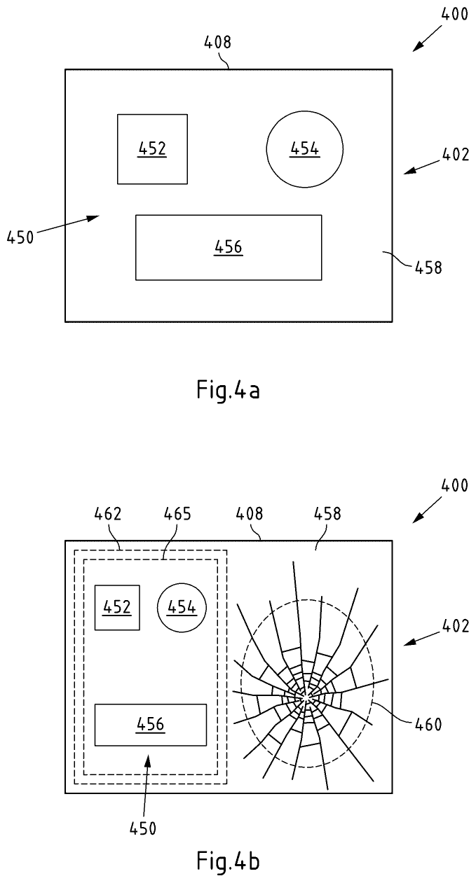

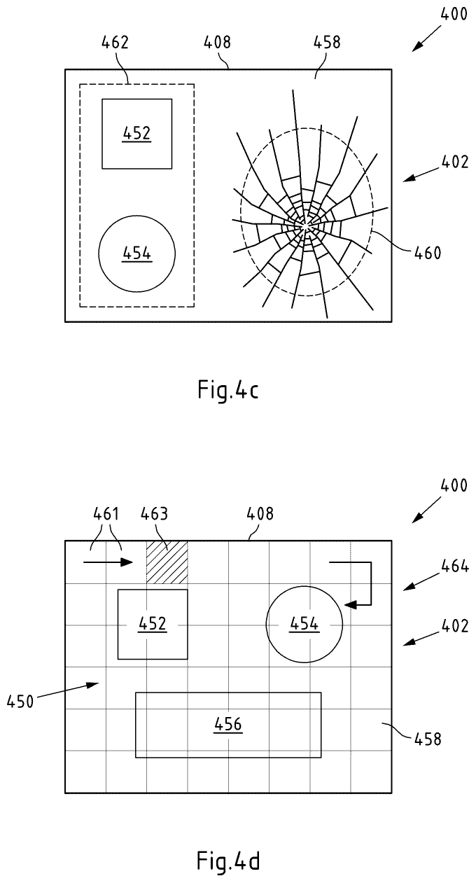

FIGS. 4a, 4b and 4c show various plan views of a further embodiment of a display device 400 according to the present invention. In order to avoid repetitions, only the differences to the embodiments according to FIG. 2 and FIGS. 3a, 3b will be explained below, otherwise reference is made to the explanations of FIG. 2 and/or FIGS. 3a, 3b. In addition, the details, such as the display control, the display illumination and the analysis module, have only been omitted for the sake of a better overview.

In particular, the display device 400 is shown in FIG. 4a with a transparent protective screen 408 in an undamaged state, while FIGS. 4b and 4c show the display device 400 with a transparent protective screen 408 in a damaged state.

As can be seen from FIG. 4a, the optical display 402 displays data content 450 with exemplary three data elements 452, 454, 456. It shall be understood that in variants of the invention, data content with more or fewer data elements may be provided. In particular, the data content and/or the data elements can be variable, for example, depending on user input.

In the undamaged state, the data elements 452, 454, 456 are arranged in a distributed manner over the entire screen surface 458. A data element 452, 454, 456 can be an item of information (e.g., trip tariff information, trip information, information about a function, fault information, parking tariff information, advertising, etc.) and/or a function field (e.g., in the case of a touch display), with which a user can, for example, select respectively call up a data element, and thus can make a user input (in a manner that is known in principle).

In FIGS. 4b and 4c, a damage has occurred to the transparent protective screen 408, for example, due to the transparent protective screen 408 being subjected to force. For example, the force may have caused cracks, as indicated in FIGS. 4b and 4c.

The analysis module can be preferably configured to determine a main damage position 460 respectively a main damage area based at least on the respective light intensity of two or more light intensity signals from two or more light sensors (not shown) distributed on the narrow sides. In particular, by evaluating the respective maximum amplitudes of the two or more light intensity signals and the respective known light sensor positions, it can be determined in which area of the screen surface 458 respectively the front side of the transparent protective screen 408 the damage is located, at least predominantly respectively essentially, that is, the main damage position 460. In other words, the analysis module can be configured to determine the substantially damage-free area 462 of the screen surface 458 respectively the front side of the transparent protective screen 408, as described above.

In preferred variants of the invention, the display controller can be configured to control the display illumination with a predefined test control signal for particularly precise determining of the main damage position 460 and/or the damage-free area 462 of the screen surface 458. The test control signal can be based on a predefined time-dependent test sequence pattern, with which, in particular, the entire screen area of the optical display can be controlled, preferably in a grid-like fashion. In particular, a grid 464 with predefined grid sub-areas 461, 463 (for example in the form of rectangles, in particular, squares) can be placed over the entire screen surface 458 of the optical display 402, as schematically indicated in FIG. 4d. Then each of these grid sub-areas 461, 463 can be activated, for example, sequentially (indicated by the arrows), in particular, with a predefined light intensity and/or light brightness and/or color. For example, each grid sub-area 461, 463 can be illuminated individually in succession, while all other grid sub-areas 461, 463 are not illuminated during this control period. In the present case, only the grid sub-area 463 is illuminated, while all other grid sub-areas 461 are not illuminated. It shall be understood that any control sequence is possible.

In particular, a previously described evaluation of the majority of the light intensity signals can be carried out for each grid sub-area. For example, the respective maximum amplitudes of the respective light intensity signals for all grid sub-areas can be compared with each other again. For example, it can be determined for which grid sub-areas 461, 463 the at least one amplitude of the plurality of light intensity signals of all grid sub-areas 461, 463 is high, in particular, exceeds a predefined minimum change. This at least one grid sub-area 461, 463 can, in particular, be determined as the main damage position and main damage position area, respectively.

The display controller can preferably be configured to change the data content 450 displayed by the optical display 402 by controlling the display illumination and/or the display layer arrangement based on the determined main damage position 460 (and in particular, the additionally determined degree of damage) and/or the determined damage-free area 462. In particular, the analysis module can provide the display controller with a determined main damage position 460 and, in particular, the determined degree of damage (and/or the determined damage-free area 462). A change in the data content 450 displayed by the optical display 402 can be performed by controlling, by the display control, with a changed control signal and/or a changed display control signal.

For example, as shown in FIG. 4b, changing the data content 450 displayed by the optical display 402 by the display controller may comprise decreasing a size of the window 465 in which the entire data content 450 is displayed (in particular, compared to FIG. 4a), depending on the determined main damage position 460 (and in particular, the additionally determined degree of damage) respectively the determined damage-free area 462 (and, if applicable, a predefined minimum window size). Furthermore, the reduced-size window 465 can be arranged respectively displayed in the damage-free area 462, that is, an area 462 that has no or only minor damage.

Alternatively or additionally, as shown in FIG. 4c, it may be provided that the data content 450 can comprise a plurality of data elements 452, 454, 456. Each data element 452, 454, 456 can be assigned a display priority. For example, a data element (e.g., 452) that should always be displayed (e.g., important information for a user, a key field that can be operated by a user, a data element that is essential for the function of the display device 400 or the device in which the display device 400 is implemented, etc.) can be given a high priority, in particular, the highest priority, while a data element (e.g., 456) that does not always have to be displayed (for example, an advertisement, an area without a keypad that can be operated by the user, a data element that is not essential for the function of the display device 400 or the device in which the display device is implemented, etc.) is given a low priority, in particular, the lowest priority.

Changing the data content 450 displayed by the optical display 402 by the display controller can comprise displaying the data elements 452, 454 in the low-damage area respectively damage-free area 462 of the optical display 402, which has no or only minor damage, depending on the respectively assigned priority of the data elements 452, 454, 456. Initially, only the at least one data element 452 is displayed in the damage-free area 462 of the optical display 402 with the highest priority. If further sub-area is available in the damage-free area 462 of the optical display 402, the at least one further data element 454 can be displayed with the second highest priority (etc.). Data elements 456 that are no longer displayed in the damage-free area 462 of the optical display 402 (due to lack of space and in particular due to priority) can be omitted altogether or displayed in the damage area of the main damage position 460.

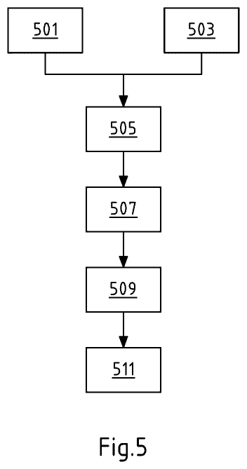

FIG. 5 shows a diagram of an embodiment of a method according to the present invention. The method is used to detect a damage to an optical display of a display device, for example, a display device according to FIGS. 2, 3a, 3b, 4a, 4b, 4c and/or 4d.

In a step 501, a (continuously) detecting is performed, by means of at least one light sensor arranged at a narrow side of a transparent protective screen of the optical display, of an emerging light intensity caused essentially by the display illumination, as already described.

In a parallel step 503, a providing of a control signal can be performed, which is applied to a display illumination of the optical display while the light intensity is being detected, as already described.

In a step 505, a detecting is performed, by an analysis module, of a damage to the transparent protective screen based on the detected light intensity and the control signal, as previously described.

Optionally, in step 507, a determining of a degree of damage of the detected damage to the transparent protective screen and/or a determining of a main damage position can be performed, as already described.

Optionally, in step 509, a changing in the data content displayed by the optical display can be performed by controlling the display illumination and/or the display layer arrangement based at least on the determined main damage position, as previously described.

Preferably, upon detecting of a damage to the transparent protective screen, in step 511, a transmitting can be performed, by a communication module, of a damage message, as described above.

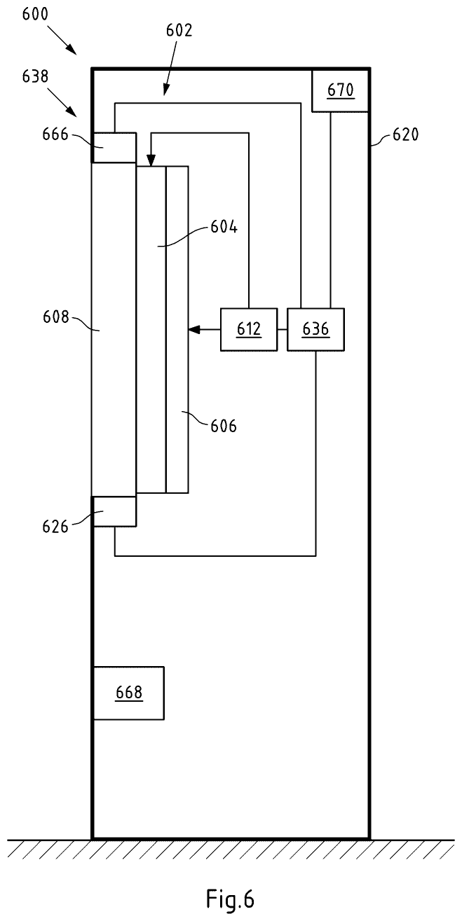

FIG. 6 shows a schematic view of an embodiment of a ticket vending machine 620 according to the present invention with a further embodiment of a display device 600 according to the present invention. In order to avoid repetitions, only the differences compared to the previous embodiments will be explained below, otherwise reference is made to the explanations, for example, of FIGS. 2 to 5.

The ticket vending machine 620, for example, for parking tickets or travel tickets, comprises, in addition to the at least one display device 600, one or more ticket processing modules 668, such as a ticket generation module, a ticket accounting module, a ticket issuing module, a ticket validation module and/or the like.

The optical display 602 (e.g., an LCD screen) of the display device 600 comprises a display illumination 606 in the form of a backlight, a display layer arrangement 604, a transparent protective screen 608 and a display controller 612. In the present case, the display controller 612 is, in particular, configured to control the display illumination 606 with a control signal and to control the display layer arrangement 604 with a display control signal.

The optical display 602 can be a touch display so that interaction between a user and the ticket vending machine 620, in particular, the at least one ticket processing module 668, is possible, for example in order to purchase and/or pay for a ticket.

In addition, the display device 600 comprises a sensor arrangement 638 with at least two light sensors 626, 666. Furthermore, the display device 600 in the present case comprises an analysis module 636 and, in particular, a communication module 670. The communication module 670 is, in particular, configured at least to transmit a damage message when a damage to the transparent protective screen 608 is detected, in particular, via a (not shown) communication network to a (not shown) control center. The control center (e.g., formed by a cloud, one or more servers, etc.) can be configured to cause a repairing of a damaged protective screen 608, in particular, in order to replace this protective screen 608.

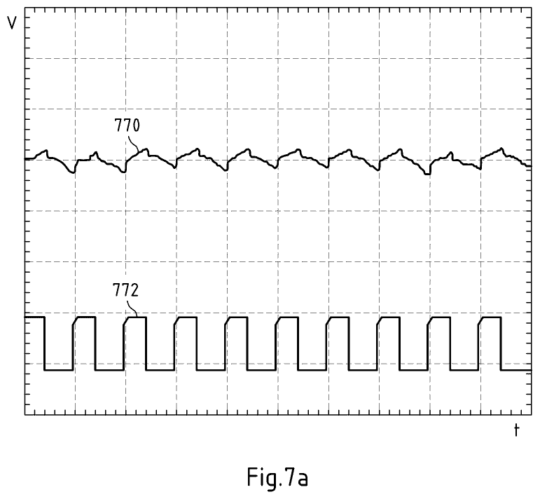

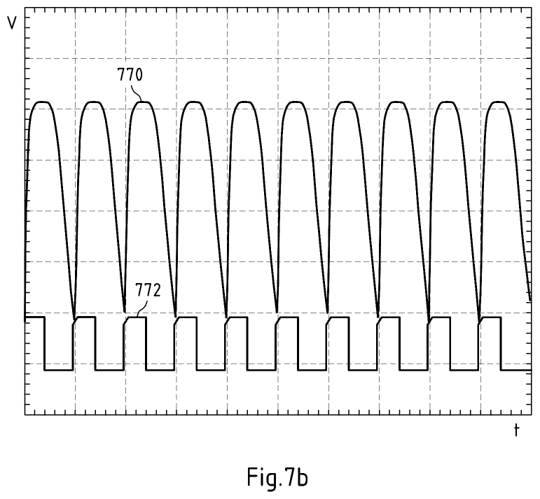

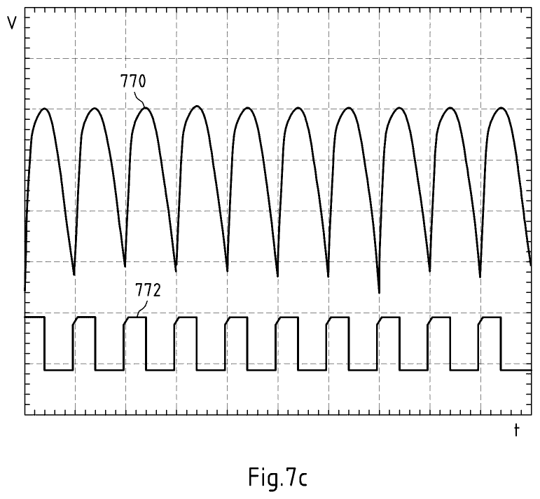

FIG. 7a shows exemplary signal curves of an intensity signal 770 of a light sensor of a display device according to the present invention and a control signal 772 (in particular, a PWM signal) of the display device in a damage-free state of the transparent protective screen. As can be derived from the maximum amplitude of the (light) intensity signal 770, the light sensor detects only a low light intensity. Together with the control signal 772, the analysis module can determine, in particular, that the transparent protective screen has no damage.

FIG. 7b shows exemplary signal curves of an intensity signal 770 of a first light sensor of a display device according to the present invention and a control signal 772 (in particular, a PWM signal) of the display device in a damaged state of the transparent protective screen. As can be derived from the maximum amplitude of the (light) intensity signal 770, the light sensor detects a high light intensity (in particular, due to the modified reflection behavior of the transparent protective screen due to the damage that has occurred). Together with the control signal 772, which is unchanged, in particular, in comparison to FIG. 7a, the analysis module can determine, in particular, that the transparent protective screen has a damage. In other words, a damage can be detected.

FIG. 7c shows exemplary signal curves of an intensity signal 770 of a second light sensor of a display device according to the present invention and a control signal 772 (in particular, a PWM signal) of the display device in a damaged state of the transparent protective screen. As can be derived from the maximum amplitude of the (light) intensity signal 770, the light sensor detects a high light intensity (in particular, due to the modified reflection behavior of the transparent protective screen due to the damage that has occurred). Together with the control signal 772, which is unchanged, in particular, compared to FIG. 7a, the analysis module can determine, in particular, that the transparent protective screen has a damage. In other words, damage can be detected.

The difference between FIGS. 7b and 7c is, in particular, that the maximum amplitude of the intensity signal 770 in FIG. 7c is lower than the maximum amplitude of the intensity signal 770 in FIG. 7b. In particular, the analysis module can determine from this that the distance between the first light sensor of the display device and the main damage position is shorter than the distance between the second light sensor of the display device and the main damage position. Since the respective sensor positions of the first light sensor and second light sensor on the transparent protective screen are known to the analysis module, the analysis module can determine the main damage position from the different maximum amplitudes of the intensity signals, as already described.

In summary, it has been recognized that a glass screen or similar is largely transparent to visible light. Only a small portion of the light entering orthogonally to the screen is reflected by scattering within a glass screen towards the edge.

This transmissive property of a glass screen changes if it is damaged, such as if it breaks. At the breakage edges within the glass screen, more light is coupled out towards the edge or narrow side due to reflection and additional scattering in the pane screen. This change in luminous flux can be detected with the help of at least one optical sensor, such as a photodiode or phototransistor and/or the like, at the edge or narrow side of the glass screen.

The display illumination, e.g., LED display illumination, is used as the light source. The evaluation electronics in the form of the analysis module can be synchronized with the control of the display illumination in order to be less sensitive to the coupling of extraneous light by means of a differential detection of the light intensity signals.

### LIST OF REFERENCE SIGNS

100 display device
102 display
104 display layer arrangement
106 display illumination
108 protective screen
110 front side
112 display control
114 narrow side
116 narrow side
118 light
120 ticket machine
192 evaluation module
194 sensor light receiver
196 sensor light source
198 sensor arrangement
200 display device
202 display
206 display illumination
208 protective screen
212 display control
214 narrow side
216 narrow side
218 light
226 light sensor
228 front side
230 back side
232 light
234 damage
236 analysis module
238 light sensor arrangement
300 display device
302 display
304 display layer arrangement
306 display illumination
308 protective screen
314 narrow side
316 narrow side
326 light sensor
328 front side
330 back side
340 narrow side
342 narrow side
344 holding frame
346 reflective layer
400 display device
402 display
408 protective screen
450 data content
452 data element
454 data element
456 data element
458 screen surface
460 main damage position
461 grid sub-area
462 damage-free area
463 grid sub-area
464 grid
465 window
501 step
503 step
505 step
507 step
509 step
511 step
600 display device
602 display
604 display layer arrangement
606 display illumination
612 display controller
620 ticket vending machine
626 light sensor
636 analysis module
638 sensor arrangement
666 light sensor
668 ticket processing module
670 communication module
770 intensity signal
772 control signal

What is claimed is:

1. A display device, comprising:
at least one optical display having a display illumination controllable by a display controller with a control signal, and having a transparent protective screen, a light sensor arrangement having at least one light sensor,
wherein the at least one light sensor is configured to detect the light intensity emerging at a narrow side of the transparent protective screen and essentially caused by the display illumination, and
an analysis module configured to detect damage to the transparent protective screen based on the detected light intensity and the control signal that is present at the display illumination during detecting of the light intensity.

2. The display device according to claim 1, wherein
the light sensor arrangement comprises only the display illumination as a light sensor source.

3. The display device according to claim 1, wherein
the control signal is a pulse width modulation signal.

4. The display device according to claim 1, wherein
the analysis module is configured to detect damage to the transparent protective screen by detecting a minimum change in the detected light intensity when the control signal is unchanged.

5. The display device according to claim 4, wherein
the analysis module is configured to determine, as the minimum change, a minimum dynamic change based on the control signal present at the display illumination during detecting of the light intensity, and
the analysis module is configured to detect damage to the transparent protective screen based on the dynamic minimum change and the detected light intensity.

6. The display device according to claim 1, wherein
the analysis module is configured to determine a difference between a maximum of the control signal and a maximum of the detected light intensity, and
the analysis module is configured to determine a degree of damage to the transparent protective screen based on the determined difference.

7. The display device according to claim 1, wherein
the light sensor arrangement comprises at least two light sensors,
the at least two light sensors are arranged at a distance from one another.

8. The display device according to claim 1, wherein
the transparent protective screen has a substantially rectangular base shape, at each of at least three of the four narrow sides of the transparent protective screen at least one light sensor is arranged.

9. The display device according to claim 7, wherein
the at least two light sensors are each configured to provide a respective light intensity signal, and
the analysis module is configured to determine a main damage position based at least on the respective light intensity of the two light intensity signals.

10. The display device according to claim 9, wherein
the display controller is configured to change the data content displayed by the optical display by controlling the display illumination and/or a display layer arrangement based on the determined main damage position.

11. The display device according to claim 1, wherein
the display controller is configured to control the display illumination with a predefined test control signal during a predefined test period,
the analysis module is configured to detect damage to the transparent protective screen based on the light intensity detected during the test period and the test control signal.

12. The display device according to claim 1, wherein
a reflective layer is arranged on at least a portion of the narrow side areas of the transparent protective screen.

13. The display device according to claim 12, further comprising
a holding frame configured to hold the transparent protective screen,
wherein the reflective layer is attached to the holding frame in such a way that the reflective layer is arranged at least on the portion of the narrow side areas of the transparent protective screen.

14. The display device according to claim 1, wherein
the at least one light sensor is surrounded by the narrow side of the transparent protective screen and an opaque encapsulation.

15. The display device according to claim 1, further comprising
at least one communication module configured to at least transmit a damage message if damage to the transparent protective screen is detected.

16. A method for detecting damage to an optical display of a display device, comprising:
detecting, by means of at least one light sensor arranged at a narrow side of a transparent protective screen of the optical display, an emerging light intensity caused essentially by the display illumination, and
detecting, by means of an analysis module, damage to the transparent protective screen based on the detected light intensity and a control signal that is present at a display illumination of the optical display during the detecting of the light intensity.

17. A ticket vending machine, comprising:
at least one ticket processing module, and
at least one display device according to claim 1.

18. The display device according to claim 7, wherein
the at least two light sensors are arranged at two different narrow sides of the transparent protective screen.

19. The display device according to claim 1, wherein
the transparent protective screen has a substantially rectangular base shape, at each of all four narrow sides of the transparent protective screen at least one light sensor is arranged.

20. The method according to claim 16, wherein
the display illumination is controllable by a display controller with the control signal, and
wherein the at least one light sensor is configured to detect the light intensity emerging at a narrow side of the transparent protective screen and essentially caused by the display illumination.
